(19) United States
(12) Patent Application Publication
(10) Pub. No.: US 2003/0173831 A1
(43) Pub. Date: Sep. 18, 2003

(54) Power distribution network

(75) Inventors: Michael Pohle, Fluelen (CH); Martin Kriegel, Unterehrendingen (CH)

Correspondence Address: BURNS, DOANE, SWECKER & MATHIS, L.L.P., P.O. Box 1404, Alexandria, VA, 22313-1404, US

(73) Assignee: ABB Schweiz AG, Baden (CH)

(21) Appl. No.: 10/378,849

(22) Filed: Mar. 5, 2003

(30) Foreign Application Priority Data
Mar. 15, 2002 (EP) 02405200.3

(51) Int. Cl. H02H 1/00

(52) U.S. Cl. 307/125

(57) ABSTRACT

The invention is based on a power distribution network having at least one polyphase overhead line (9) and having at least one circuit breaker which is provided for protection of the at least one overhead line (9). The aim is to provide a polyphase power distribution network in which no additional capacitors are required for reduction of the system-dependent gradient of the returning voltage. This is achieved by providing a hybrid circuit breaker (16) as the circuit breaker. The power distribution network (1) provided in this way can be produced more cost-effectively.

### TECHNICAL FIELD

The invention is based on a polyphase electrical power distribution network as claimed in the precharacterizing clause of claim 1.

### PRIOR ART

A three-phase power distribution network, which can be operated at high voltage, is known from the article by Rainer Bitsch and Friedrich Richter in the journal etz-a, Vol. 98 (1977), pages 137 to 141. This power distribution network has overhead lines which connect different switching stations and loads. Circuit breakers are provided in the switching stations in this power distribution network and are used, inter alia, for protection of the lines and of the loads against consequential damage caused by a short circuit. In the event of damage, these circuit breakers selectively disconnect the faulty areas of the power distribution network. A commercially available circuit breaker generally copes with the switching situations that occur in the power distribution network. However, if the power distribution network is subjected to a comparatively high short-circuit power with fault currents in the region of about 40 kA to 50 kA, it is possible, however, that the commercially available circuit breakers will not invariably safely cope with the specific switching situation of a short-line fault.

When disconnecting a short-line fault, particularly steep gradients occur in the returning voltage in the initial quenching phase of the circuit breaker after quenching of the switching arc in the switching gap between the switching contacts, and, in conventional circuit breakers, these can lead to undesirable restriking of the switching gap, and thus to failure of the circuit breaker. In order to avoid such spurious switching operations, measures are provided in the polyphase power distribution network to prevent the possibility of such steep gradients occurring in the returning voltage. Proven means include the use of capacitors in the power distribution network, which reduce the natural frequency of the power distribution network, which may be regarded as an LC tuned circuit, to such an extent that the gradient of the returning voltage assumes values which are now only comparatively small and which can be coped with by conventional circuit breakers. In general, the capacitors are installed between the high-voltage potential of the power distribution network and ground.

This installation of capacitors is complex with regard to the costs and the space required for these elements. Furthermore, each of the capacitors has an isolating gap to ground, which must be maintained, thus resulting in additional costs, and with the time required for this maintenance somewhat restricting the availability of the power distribution network. The installation of additional capacitors can change the natural frequency of the power distribution network such that ferroresonances are possible. These ferroresonances can lead to undesirable overvoltages in the network during switching processes.

### DESCRIPTION OF THE INVENTION

The invention, as it is characterized in the independent claim, achieves the object of providing a polyphase power distribution network, in which no additional capacitors are required in order to reduce the system-dependent gradient of the returning voltage.

In the power distribution network according to the invention, with at least one polyphase overhead line, a hybrid circuit breaker is provided as the circuit breaker for protection of the at least one overhead line. The hybrid circuit breaker has at least two switching chambers, which are operated with different quenching media. The at least one first of these switching chambers is designed to cope with high holding voltages continuously, and the at least one second of these switching chambers is designed to cope with comparatively high initial gradients of the returning voltage. In one preferred embodiment, at least one vacuum switching chamber is provided as the second switching chamber. The use of other switching and isolation media is invariably feasible in hybrid circuit breakers such as these.

The advantages achieved by the invention are that there is no need for the additional capacitors, thus reducing the space required for the switching stations for the power distribution network, so that the construction costs for producing the power distribution network are advantageously reduced. Furthermore, because of the lack of these capacitors, the additional distances which must be bridged for isolation and the complexity for regular cleaning of this insulation are also avoided. The lack of the additional capacitors also overcomes the risk of undesirable ferroresonances occurring in the power distribution network.

The invention, its development and the advantages which can be achieved by it will be explained in more detail in the following text with reference to the drawing, which represents only one possible embodiment approach.

### BRIEF DESCRIPTION OF THE DRAWING

In the figures:

FIG. 1 shows the equivalent circuit of a part of a conventionally connected power distribution network, and

FIG. 2 shows the equivalent circuit of a part of a power distribution network simplified according to the invention.

Only those elements which are required for direct understanding of the invention are illustrated and described.

### APPROACHES TO IMPLEMENTATION OF THE INVENTION

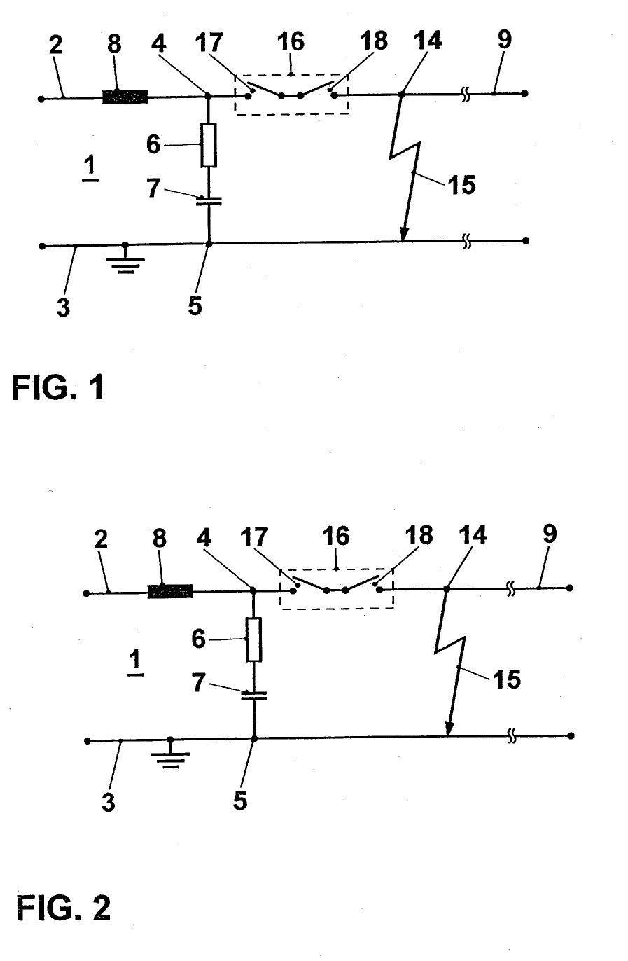

FIG. 1 shows a highly simplified single-phase equivalent circuit of a conventionally constructed power distribution network 1. The scissor-type disconnectors, grounding devices and instrument transformers which are generally always present are not shown, nor are the power generating facilities. This power distribution network 1 has a high-voltage section 2 at high potential, and a grounded section 3. A non-reactive resistor 6 is connected in series with a capacitor 7 between a terminal 4, which is arranged in the high-voltage section 2, and a terminal 5, which is arranged in the grounded section 3. The resistor 6 represents the resistive component of the network impedance, and the capacitor 7 represents the capacitive component of the network impedance, while the inductance 8 connected upstream of the terminal 4 represents the inductive component of the network impedance. An overhead line 9 originates from the terminal 4. A circuit breaker 10 is provided at the start of this overhead line 9, in the same way as in the other end (which is not shown) and, in the event of a fault, these two circuit breakers disconnect the overhead line 9.

A terminal 11 is provided immediately after the circuit breaker 10. An additional capacitor 13 is connected between this terminal 11 and a terminal 12, which is arranged in the grounded section 3. An identical additional capacitor is also provided at the other end of the overhead line 9. If a ground short 15 now occurs, for example as a result of a lightning strike, at a fault location 14, then the two circuit breakers must disconnect the overhead line 9. If the fault location 14 is comparatively close to the circuit breaker 10, that is to say in the area in which the occurrence of a short-line fault can be referred to with respect to this circuit breaker 10, then the additional capacitor 13 limits the gradient of the rise of the returning voltage to values which can be coped with without any problems by the circuit breaker 10. The traveling wave processes which are caused by the short-line fault on the piece of overhead line 9 between the circuit breaker 10 and the fault location 14 then cannot cause any disturbances.

FIG. 2 shows a highly simplified single-phase equivalent circuit of a power distribution network 1 of simplified design according to the invention. The scissor-type disconnectors, grounding devices and instrument transformers which are generally always present are not shown, neither are the power generating facilities. This power distribution network 1 has a high-voltage section 2 which is at high potential, and a grounded section 3. A non-reactive resistor 6 is connected in series with a capacitor 7 between a terminal 4, which is arranged in the high-voltage section 2, and a terminal 5, which is arranged in the grounded section 3. The resistor 6 represents the resistive component of the network impedance, and the capacitor 7 represents the capacitive component of the network impedance, while the inductance 8 which is connected upstream of the terminal 4 represents the inductive component of the network impedance. An overhead line 9 originates from the terminal 4.

A hybrid circuit breaker 16 is provided at the start of this overhead line 9, and likewise at the other end (which is not illustrated), and these two hybrid circuit breakers disconnect the overhead line 9 in the event of a fault. If a ground fault 15 now occurs, for example due to a lightning strike, at a fault location 14, then the two hybrid circuit breakers disconnect the overhead line 9 correctly. They also disconnect the overhead line 9 in the event of a short-line fault, since they cope with all the gradients that are possible in power distribution networks 1 for the rise of the returning voltage. There is therefore no need in this case for capacitors to reduce the rise of the returning voltage.

In one preferred embodiment, the hybrid circuit breaker 16 has two series-connected switching chambers 17 and 18, of which the first switching chamber 17 is in the form of a chamber filled with insulating gas, while the second switching chamber 18 is in the form of a vacuum switching chamber. The first switching chamber 17 is designed to cope with high holding voltages (operating voltages) continuously. The second switching chamber 18 is designed to cope with comparatively high initial gradients of the returning voltage, and thus copes with the comparatively steep gradient of the rise of the returning voltage in the time period shortly after quenching of the disconnection arc. During this time period, the switching gap in the first switching chamber 17 continues to be blown and to be cleaned of conductive switching residues, so that, after this, it achieves a sufficient dielectric strength to withstand the further rise of the returning voltage and, after this, the operating voltage. The hybrid circuit breaker 16 is also provided with effective voltage control, which ensures that neither of the two switching chambers 17 and 18 is dielectrically overloaded during the disconnection process or during normal operation.

The lack of the additional capacitors also results in the major advantage that there is a high probability that the natural frequency of the power distribution network will be sufficiently far away from the range in which damaging ferroresonances can occur. The operational reliability and availability of the power distribution network are thus advantageously improved.

### LIST OF DESIGNATIONS

1 Power distribution network

2 High-voltage section

3 Grounded section

4, 5 Terminal

6 Resistor

7 Capacitor

8 Inductance

9 Overhead line

10 Circuit breaker

11, 12 Terminal

13 Additional capacitor

14 Fault location

15 Ground short

16 Hybrid circuit breaker

17, 18 Switching chamber

1. A power distribution network having at least one polyphase overhead line (9), having at least one circuit breaker which is provided for protection of the at least one overhead line (9), wherein the at least one circuit breaker is provided as hybrid circuit breaker (16) with at least two switching chambers (17, 18) which are operated with different quenching media, that the at least one first of these switching chambers (17) is designed to cope with high holding voltages continuously, that the at least one second of these switching chambers (18) is designed to cope with comparatively high initial gradients of the returning. voltage, characterized in
that at least one vacuum switching chamber is provided as the second switching chamber.

2. The power distribution network as claimed in claim 1, characterized in
that no additional capacitors (13) are provided.
